(19) United States
(12) Patent Application Publication
(10) Pub. No.: US 2007/0262623 A1
(43) Pub. Date: Nov. 15, 2007

(54) Swivel and tilt bicycle seat assembly

(76) Inventor: Thomas A. Fortt, Tacoma, WA (US)

Correspondence Address: DEAN A. CRAINE, SUITE 140, 400 - 112TH AVENUE NE, BELLEVUE, WA, 98004, US

(21) Appl. No.: 11/803,011

(22) Filed: May 10, 2007

Related U.S. Application Data
(60) Provisional application No. 60/799,235, filed on May 10, 2006.

(51) Int. Cl. B62J 1/00

(52) U.S. Cl. 297/215.13

(57) ABSTRACT

A swivel and tilt bicycle seat assembly designed to eliminate pressure on a rider's scrotum by using a rectangular seat section that freely swivels side-to-side and freely tilts in a fore and aft direction as the rider pedals. The assembly includes a seat post attachment mechanism that attaches to a seat post. The assembly includes a rectangular seat section with two opposite upward curved side wings. Attached to the bottom surface of the seat is a rotating bracket that rotates freely in 360 degrees. The upper ends of the rotating bracket is attached to a bolt located on the bottom surface of the seat section that allows the seat section to tilt in a fore and aft direction support base that can be selectively adjusted and fixed in a desired fore and aft position for different riders.

This is a utility patent application which claims benefit of U.S. provisional application No. 60/799,235 filed on May 10, 2006.

### BACKGROUND OF THE INVENTION

1. Field of the Invention

This invention pertains to bicycle seats and more particularly to bicycle seats that are more comfortable when riding any distance.

2. Description of the Related Art

Most casual bicycle riders like to sit while pedaling. A bicycle seat typically includes a horn that extends forward between the rider's legs when sitting. For men, the horn can be particularly uncomfortable because it applies pressure against the scrotum and testicles. When pedaling a bicycle, the legs must flex, extend and rotate in an alternating manner around the hip joints. The alternating movement of the legs around the horn causes the buttocks to rotate side to side. As a result, the horn becomes a major obstacle that causes irritation.

An important benefit of the horn on a bicycle seat is that it helps to keep the rider's buttocks aligned on the seat.

What is needed is a bicycle seat that does not include a horn yet allows a rider to comfortably sit and aligned on the seat and pedal.

### SUMMARY OF THE INVENTION

It is an object of the present invention to provide a bicycle seat assembly that does not include a horn.

It is another object of the present invention to provide a bicycle seat assembly that allows the rider to sit comfortably while pedaling.

These and other objects of the invention are met by the bicycle seat assembly disclosed herein that includes a relatively wide, short seat section, a rotating bracket and a fore and aft tilting mechanism. The rotating bracket allows the seat section to rotate up to 360 degrees. The fore and aft tilting adjustment mechanism allows the seat to pivot freely in a forward and backward direction approximately 60 degrees around the seats post. The seat assembly also includes an adjustable post adjustment mechanism that enables the seat assembly to be selectively adjusted over the bicycle's seat tube.

In the preferred embodiment, the seat section is rectangular-shape and includes two opposite, upward extending side wings which help to maintain the rider's buttocks over the seat section while pedaling. In the preferred embodiment, the seat section includes a rigid lower base made of lightweight material and covered with foam padding and a vinyl or leather outer layer.

The rotating bracket includes two parallel flanges that extend upward from a circular base. Attached to the bottom of the seat section is at least one holding clip in which a longitudinally aligned bolt is placed. The ends of the bolt are threaded and extend through holes formed on the upper ends of the two flanges. During use, the clip, the bolt and the two flanges enable the seat section to tilt in a fore and aft direction. An optional biasing means may be disposed between the bottom surface of the seat section and the bolt or rotating bracket so that the seat section returns to a horizontal resting position when not in use.

Located below the circular base is a support base. A post extends upward from the support base on which the circular base rotates. Disposed between the circular base and the support base are ball bearings that allows the circular base to rotate freely 360 degrees over the support base.

Attached to the bottom surface of the support base are two downward extending plates with an elongated slot formed therein. During assembly, the head on a seat post is disposed between the two plates. A transversely aligned bore is formed in the head which is aligned and registered with the two elongated slots formed on the two plates. A bolt is inserted through the two slots and the bore and a nut is attached to the threaded end on the bolt which is tightened to securely attach the plates to the modified seat post. The seat post is then attached to the bicycle's seat tube. During use, the angle of the support base may be adjusted on the head of the modified seat post which enables the user to finely adjust the tilting angle of the seat section.

### DESCRIPTION OF THE DRAWINGS

FIG. 1 is a perspective view of a side elevational view of the bicycle with the swivel bicycle seat assembly attached thereto.

FIG. 2 is a perspective view of the swivel bicycle seat assembly.

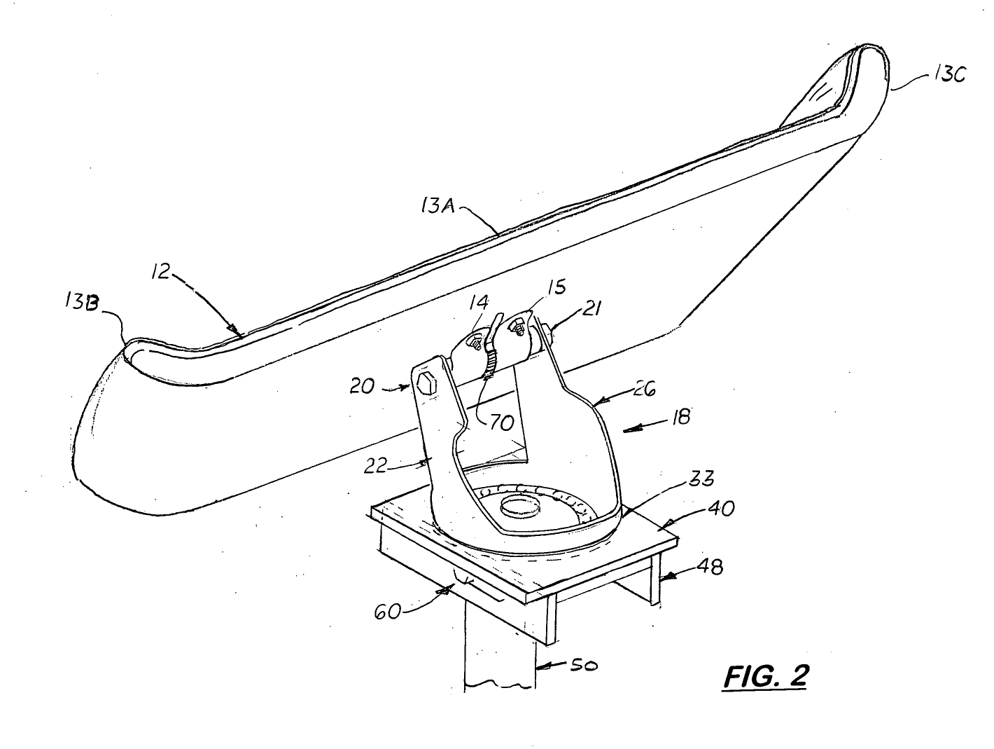

FIG. 3 is a side elevational view of the swivel seat showing the fore and aft movement of the swivel seat assembly.

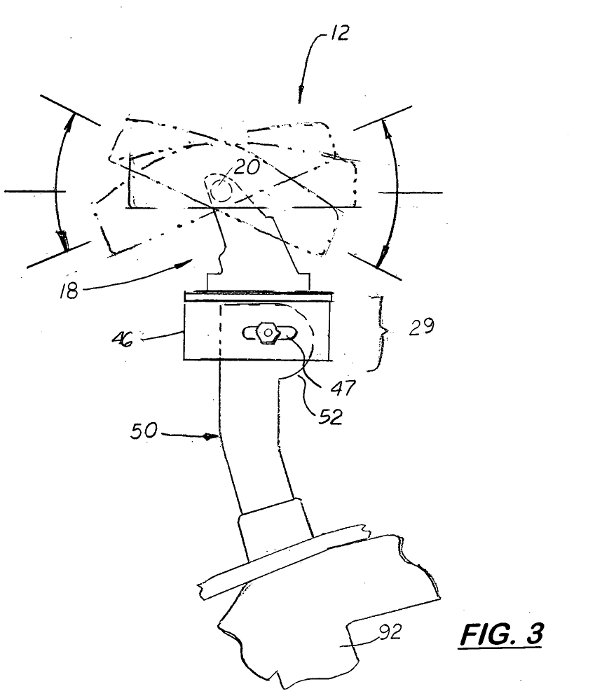

FIG. 4 is a top plan view of the swivel seat assembly showing invention.

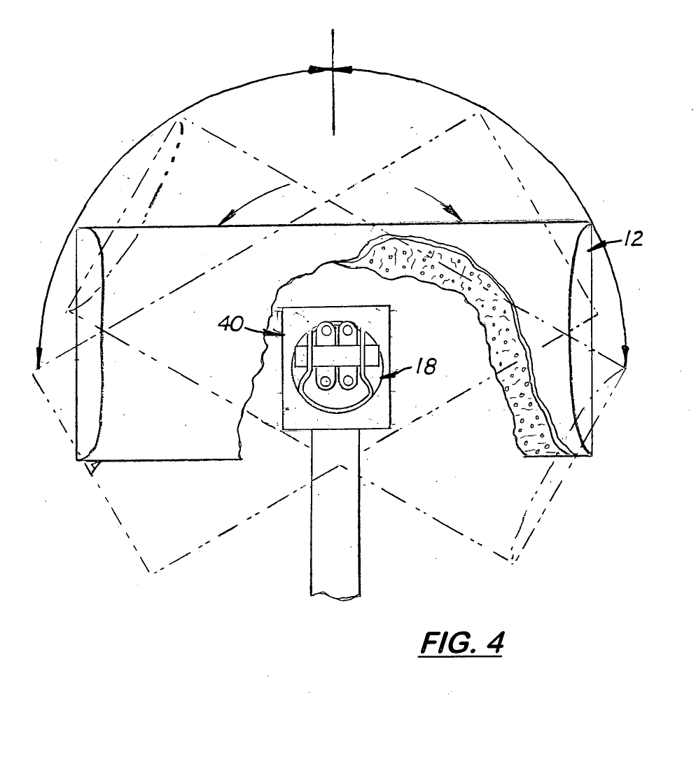

FIG. 5 is a partial front elevational view of the swivel seat assembly.

### DESCRIPTION OF THE PREFERRED EMBODIMENT(S)

Referring to the above Figs. there is shown a bicycle seat assembly 10 that includes a flat bench style seat section that is able to freely rotate in 360 degrees around a seat post 50 and tilt in a fore and aft direction while pedaling

In the preferred embodiment, the seat section 12 is designed to support only the rider's buttocks. The seat section 12 is rectangular in shape with two gently curved side wings 13B, 13C. In the preferred embodiment, the seat section 12 includes a flat middle section 13A and two opposite upward curved side wings 13B, 13C. The section seat 12 includes a rigid lower base covered with a foam layer and a vinyl or leather outer layer.

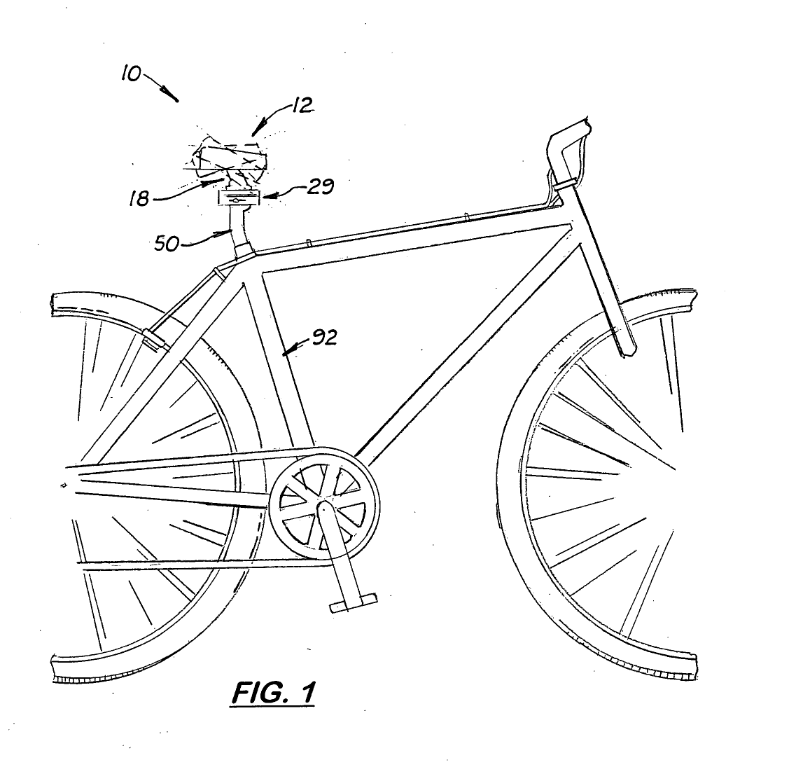

Located below the seat section 12 is a rotating bracket 18 that enables the seat section 12 to simultaneously tilt and rotate around the seat post 50. The rotating bracket 18 includes two parallel flanges 22, 26 that extend upward from a circular base 33. Attached to the bottom surface of the seat section 12 are two U-shaped holding clips 14, 15. Disposed through the two clips 14, 15 is a longitudinally aligned bolt 20. The end of the bolt 20 is threaded and extends through holes (not shown) formed on the upper ends of the two flanges 22, 26. A nut 21 is attached to the threaded end of the bolt 20 to securely hold the bolt 20 between the two flanges 22, 26. During use, the clips 14,15 the bolt 20 and the two flanges 22, 26 enable the seat section 12 to tilt in fore and aft direction as shown in FIG. 1.

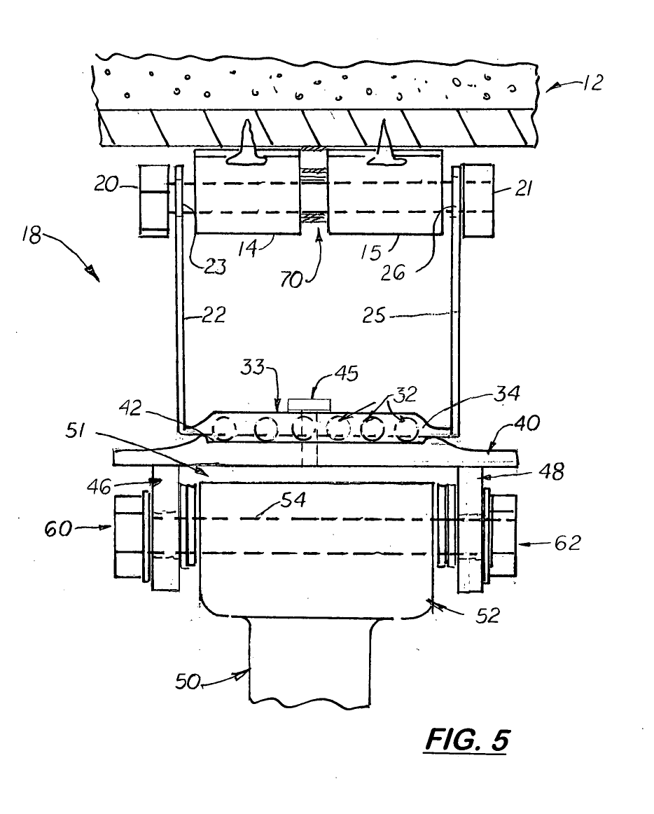

Formed on the bottom surface of the circular base 33 is a ball bearing raceway 34. Located below the circular base 33 is a support plate 40 with a second ball bearing raceway 42 formed thereon directly below the raceway 34 (see FIG. 5). A post 45 is coaxially aligned between the two raceways 34, 42 and extends downward through the circular base 33 to the support base 40. The post 45 securely holds the support base 40 and the circular base 33 together. Disposed between the raceways 34, 42 are a plurality of ball bearings 32 which enable the circular base 33 to freely rotate 360 degrees over the support plate 40.

Perpendicularly aligned and attached to the bottom surface of the support plate 40 are two parallel plates 46, 48 with longitudinally aligned elongated slots 47, 49, respectively, formed therein. During assembly, the head 52 on a seat post 50 is disposed in the space 51 between the two plates 46, 48. A transversely aligned bore 54 is formed in the head 52 which is aligned and registered with the two elongated slots 47, 49 formed on the two plates 46, 48, respectively. A bolt 60 is inserted through the two slots 47, 49 and the bore 54 and a nut 62 is attached to the threaded end and tightened to securely attach the rotating bracket 35 to the seat post 50. The lower end of the seat post 50 is then attached to the bicycle's seat tube 92.

An optional biasing means such as spring 70, may be disposed before the bottom surface of the seat section 12 and the bolt 20 which automatically returns the seat section 12 to a horizontally position when not used. When pedaling, the seat section 12 automatically rotates in alternate directions with the extended leg. The angle of the seat section 12 is slated slightly forward so that the rider's buttocks are supported.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A swivel and tilt bicycle seat assembly, comprising:
a. a rectangular seat section;
b. a seat post capable of being attached to a bicycle seat tube;
c. a fore and aft adjustable mounting mechanism disposed between said seat section and said seat post; and,
d. a rotating seat mechanism disposed between said seat section and said seat post enabling said seat section to freely rotate 360 degrees over said seat post.

2. The bicycle seat assembly, as recited in claim 1, further including said seat section including a flat middle section and two upward curved side wings.

3. The bicycle seat assembly, as recited in claim 1, further including a biasing means attached to said seat section enabling said seat section to a horizontal position when not in use.

4. The bicycle seat assembly, as recited in claim 2, further including a biasing means attached to said seat section enabling said seat section to a horizontal position when not in use.

5. A swivel and tilt bicycle seat assembly, comprising:
a. a rectangular seat section with a middle flat section and two opposite, upward curved side wings, said seat section including a bottom surface;
b. rotating bracket that includes two parallel flanges perpendicularly aligned and attached to a base, said flanges including a distal end;
c means for pivotally attaching said distal ends of said flanges to said bottom surface of said seat section thereby enabling said seat section to tilt in a fore and aft direction over said rotating bracket;
d. a support plate located below said rotating bracket, said support plate including a means for connecting said support plate to a seat post;
e. a set of ball bearings disposed between said base on said rotating bracket and said support thereby enabling said seat assembly to freely rotate over said seat post; and,
f. a biasing mean for reposition said seat section in a substantially horizontal position when said seat section is not in use.
